(19) United States
(12) Patent Application Publication
(10) Pub. No.: US 2025/0338166 A1
(43) Pub. Date: Oct. 30, 2025

(54) DELAY-AWARE RESOURCE ALLOCATION FOR EXTENDED REALITY COMMUNICATIONS

(71) Applicant: Lenovo (Singapore) Pte. Ltd., Singapore (SG)

(72) Inventors: Razvan-Andrei STOICA, Essen (DE); Joachim LÖHR, Wiesbaden (DE); Hossein BAGHERI, Urbana, IL (US)

(21) Appl. No.: 19/032,218

(22) Filed: Jan. 20, 2025

Related U.S. Application Data
(60) Provisional application No. 63/623,488, filed on Jan. 22, 2024.

(51) Int. Cl. H04W 28/02; H04L 65/65; H04W 28/06

(52) U.S. Cl. CPC H04W 28/0268; H04L 65/65; H04W 28/06

(57) ABSTRACT

Various aspects of the present disclosure relate to delay-aware scheduling enhancements of radio resource allocation for XR multimedia applications. For example, the apparatuses, systems, and methods described herein can leverage an absolute sender time to determine a remaining delay budget of Protocol Data Units (PDUs)/PDU Sets within XR application traffic. Using the determined remaining delay budgets, the systems and methods can facilitate media-aware and delay-aware radio resource allocation scheduling by a network entity.

### CROSS REFERENCE TO RELATED APPLICATIONS

This application claims priority to U.S. Provisional Patent Application No. 63/623,488, filed on Jan. 22, 2024, entitled DELAY-AWARE RESOURCE ALLOCATION FOR EXTENDED REALITY COMMUNICATIONS, which is hereby incorporated by reference in its entirety.

### TECHNICAL FIELD

The present disclosure relates to wireless communications, and more specifically to radio resource allocation for extended reality (XR) multimedia applications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Extended Reality, or XR, encompasses different types of realities, including virtual reality (VR), which can be a rendered version of a delivered visual and audio scene, augmented reality (AR), where a user is provided with content overlaid upon a currently viewed environment, mixed reality (MR), where virtual elements are inserted into a physical scene, and so on. Thus, XR can refer to real and/or virtual environments or human-machine interactions generated by computer technology and wearables.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support and provide delay-aware scheduling enhancements of radio resource allocation for XR multimedia applications.

Some implementations of the method and apparatuses described herein may further include a user equipment UE comprising at least one memory and at least one processor coupled with the at least one memory and configured to cause the UE to configure the UE with a first configuration associated with timing information for multiple protocol data units (PDUs), receive the multiple PDUs from a multimedia sender via a first protocol layer, determine delay timing information for the multiple PDUs based on the first configuration, wherein the determined delay timing information corresponds to multiple service data units (SDUs) associated with the multiple PDUs at a second protocol layer, generate new PDUs at the second protocol layer that are based at least in part on the multiple SDUs, wherein each new PDU of the second protocol layer includes at least one SDU of the multiple SDUs and a corresponding header, and transmit the new PDUs generated at the second protocol layer to a network entity.

In some implementations of the method and apparatuses described herein, the processor is further configured to cause the UE to determine a transmission priority for each PDU of the new PDUs based on the determined delay timing information that corresponds to the multiple SDUs.

In some implementations of the method and apparatuses described herein, the processor is further configured to cause the UE to transmit the new PDUs based on the determined transmission priority, by: triggering a delay status reporting (DSR) procedure corresponding to the new PDUs, wherein the DSR procedure includes reporting to the network entity timing information that is based on the delay timing information, dynamically updating a logical channel prioritization (LCP) of a logical channel associated with the transmission of the new PDUs based on a second configuration for the UE, wherein the second configuration includes a parameter set, including the following parameters: alternate logical channel priorities, alternate priority bit rates (PBRs), or alternate bucket size durations (BSDs), and grouping one or more logical channels to a Logical Channel Group (LCG), wherein the LCG is mapped to a common multi-modal service ID associated with the new PDUs of the multimedia sender, and wherein the multi-modal service ID enforces a common set of Quality of Service (QoS) and multi-modal synchronization parameters for the one or more logical channels of the LCG; or combinations thereof.

In some implementations of the method and apparatuses described herein, the first protocol layer is an Internet Protocol (IP) layer.

In some implementations of the method and apparatuses described herein, the second protocol layer is a Packet Data Convergence Protocol (PDCP) layer.

In some implementations of the method and apparatuses described herein, the processor is further configured to cause the UE to determine multiple PDCP discard timers based on the delay timing information that corresponds to the multiple SDUs.

In some implementations of the method and apparatuses described herein, the processor is further configured to cause the UE to receive an indication of the first configuration, by: a UE programmatic interface exposed to the multimedia sender, a dynamic policy request sent by a Media Session Handler (MSH) to a second network entity and determined based at least in part by the multimedia sender, a UE programmatic interface exposed to the MSH, or combinations thereof.

In some implementations of the method and apparatuses described herein, the processor is further configured to cause the UE to receive the multiple PDUs from the multimedia sender via a communication medium, including: a shared memory interface, a tethered wireless communications interface, or a tethered wired communications interface.

In some implementations of the method and apparatuses described herein, the multiple PDUs received from the multimedia sender are part of a PDU Set that includes a PDU Set information header.

In some implementations of the method and apparatuses described herein, the processor is configured to determine the delay timing information for the multiple PDUs received from the multimedia sender based on identifying sender timing information within encapsulated protocol headers of the PDU Set.

In some implementations of the method and apparatuses described herein, the encapsulated protocol headers include real-time protocol (RTP) header extension elements containing timing information.

In some implementations of the method and apparatuses described herein, the delay timing information includes at least one of the following information elements: a multimedia sender absolute timestamp that is mapped to an absolute time instance at which the multimedia sender released the multiple PDUs to the UE, a multimedia sender absolute timestamp that is mapped to an absolute time instance at which the multimedia sender released the PDU Set to the UE, an elapsed timestamp that corresponds to a timing interval that elapsed between the multimedia sender releasing the multiple PDUs to the UE and the UE receiving the multiple PDUs at the first protocol layer, an elapsed timestamp that corresponds to a timing interval that elapsed between the multimedia sender releasing the PDU Set to the UE and the UE receiving at least one PDU of the PDU Set at the first protocol layer, a remaining delay budget that determines a difference between a transmission delay budget of the multiple PDUs and the elapsed timestamp of the PDU, or a remaining delay budget that determines a difference between a transmission delay budget of the PDU Set and the elapsed timestamp of the PDU Set.

In some implementations of the method and apparatuses described herein, the processor is further configured to cause the UE to report a capability to determine the delay timing information to the network entity via an information element that is part of a UE traffic assistance information for uplink (UL), or a UE capability radio resource control (RRC) message.

Some implementations of the method and apparatuses described herein may further include a processor for wireless communication, comprising at least one controller coupled with at least one memory and configured to cause the processor to configure the processor with a first configuration associated with timing information for multiple PDUs, receive the multiple PDUs from a multimedia sender via a first protocol layer, determine delay timing information for the multiple PDUs based on the first configuration, wherein the determined delay timing information corresponds to multiple SDUs associated with the multiple PDUs via a second protocol layer, generate new PDUs at the second protocol layer that are based at least in part on the multiple SDUs, wherein each new PDU of the second protocol layer includes at least one SDU of the multiple SDUs and a corresponding header, and transmit the new PDUs generated at the second protocol layer to a network entity.

In some implementations of the method and apparatuses described herein, the controller is further configured to cause the processor to determine a transmission priority for each PDU of the new PDUs based on the determined delay timing information that corresponds to the multiple SDUs.

In some implementations of the method and apparatuses described herein, the controller is further configured to cause the UE to transmit the new PDUs based on the determined transmission priority, by triggering a DSR procedure corresponding to the new PDUs, wherein the DSR procedure includes reporting to the network entity timing information that is based on the delay timing information, dynamically updating an LCP of a logical channel associated with the transmission of the new PDUs based on a second configuration for the processor, wherein the second configuration includes a parameter set, including the following parameters: alternate logical channel priorities, alternate PBRs, or alternate BSDs, grouping one or more logical channels to an LCG, wherein the LCG is mapped to a common multi-modal service ID associated with the multiple PDUs of the multimedia sender, and wherein the multi-modal service ID enforces a common set of QoS and multi-modal synchronization parameters for the one or more logical channels of the LCG, or combinations thereof.

In some implementations of the method and apparatuses described herein, the first protocol layer is an IP layer.

In some implementations of the method and apparatuses described herein, the second protocol layer is a PDCP layer.

Some implementations of the method and apparatuses described herein may further include a method performed by a UE the method comprising configuring the UE with a first configuration associated with timing information for multiple PDUs, receiving the multiple PDUs from a multimedia sender via a first protocol layer, determining delay timing information for the multiple PDUs based on the first configuration, wherein the determined delay timing information corresponds to multiple SDUs associated with the multiple PDUs via a second protocol layer, generating new PDUs at the second protocol layer that are based at least in part on the multiple SDUs, wherein each new PDU of the second protocol layer includes at least one SDU of the multiple SDUs and a corresponding header, and transmitting the new PDUs generated at the second protocol layer to a network entity.

In some implementations of the method and apparatuses described herein, the method further comprises determining a transmission priority for each PDU of the new PDUs based on the determined delay timing information that corresponds to the multiple SDUs.

Some implementations of the method and apparatuses described herein may further include a network entity, comprising at least one memory and at least one processor coupled with the at least one memory and configured to cause the network entity to receive delay timing information for multiple PDUs that corresponds to multiple SDUs associated with the multiple PDUs and prioritize and allocate radio resources for the multiple PDUs based on the received delay timing information.

In some implementations of the method and apparatuses described herein, the processor is configured to cause the network entity to receive the delay timing information via an information element (IE) that indicates a remaining delay budget for the multiple PDUs.

In some implementations of the method and apparatuses described herein, the processor is configured to cause the network entity to receive the delay timing information via an IE that indicates a remaining delay budget for a PDU Set that includes the multiple PDUs.

### BRIEF DESCRIPTION OF THE DRAWINGS

FIG. 1 illustrates an example of a wireless communications system in accordance with aspects of the present disclosure.

FIG. 2 illustrates an example measurement procedure between an XR client and an XR responder in accordance with aspects of the present disclosure.

FIG. 3 illustrates an example block diagram that depicts uplink delay-aware radio resource allocation in accordance with aspects of the present disclosure.

FIG. 4 illustrates an example block diagram that depicts components of a UE that determine a remaining delay budget for a delay-aware radio resource allocation in accordance with aspects of the present disclosure.

FIG. 5 illustrates an example of a user equipment (UE) in accordance with aspects of the present disclosure.

FIG. 6 illustrates an example of a processor in accordance with aspects of the present disclosure.

FIG. 7 illustrates an example of a network equipment (NE) in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

XR communications, such as those that support content delivery for multimedia applications (e.g., interactive or immersive media applications) often have challenging latency and data rate requirements associated with content delivery in both uplink (UL) and downlink (DL) directions. At scale, such requirements are often not met by lower wireless network layers. For example, the transmission of high data rates over a wireless medium within a short delay budget, constrained by overall latency requirements of XR applications, can lead to various issues or problems.

Radio resource allocation scheduling can enhance scheduling decisions when the scheduling is both media-aware and delay-aware. For example, marking protocol data unit (PDU) Sets in a user plane via protocol header extensions of a multimedia real-time transport protocol (RTP) can facilitate media-aware scheduling. A PDU Set may be a group of PDUs (e.g., one or more) that logically represent the same content at an XR application layer, such as an Application Data Unit (e.g., a video frame, a video slice, and so on).

However, current allocation and scheduling policies are not delay-aware. For example, a radio transmitter of a UE may not have information or knowledge of a remaining delay budget of a PDU or PDU Set. Instead, these radio resource allocation and scheduling policies often assume a static delay within a transport/core layer in DL and/or from the application to a modem interface in UL. Such assumptions can disregard dynamic transport and delay changes between a multimedia source or sender (e.g., an XR application) and the radio transmitter (e.g., a UE, or a base station) and/or can be inaccurate relative to tight remaining delay budgets utilized or attained by a radio resource scheduler when servicing XR applications.

Thus, the technology described herein supports and provides delay-aware scheduling enhancements of radio resource allocation for XR multimedia applications. For example, the systems and methods described herein can leverage an absolute sender time to determine a remaining delay budget of PDUs/PDU Sets within XR application traffic. Using the determined remaining delay budgets, the systems and methods can facilitate radio resource allocation scheduling that is both media-aware and delay-aware, among other benefits.

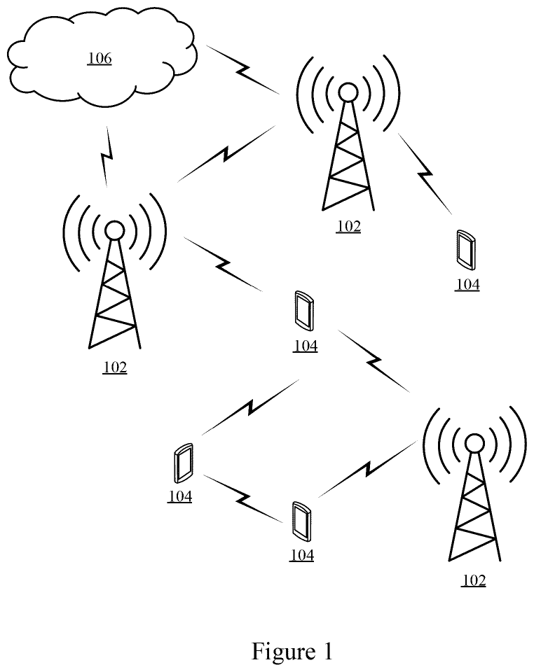

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the technology provides systems and methods that enhanced radio resource allocation and scheduling for XR multimedia applications, where the allocation/scheduling is both media-aware and delay-aware.

An XR Media (XRM) feature in 3GPP Release 18 introduced a PDU Set, which can include one or more PDUs. In some cases, an application layer utilizes all PDUs of a PDU Set when using a corresponding unit of information generated at the application layer (e.g., a frame or video slice). In other cases, the application layer can recover the information unit with some of the PDUs of the PDU Set.

A PDU Set is associated with certain QoS requirements for delay budget and error rate. For example, a PDU Set Delay Budget (PSDB) defines an upper bound for a time that a PDU Set may be delayed between a UE and an N6 termination point at a UPF (User Plane Function). PSDB applies to a DL PDU Set received by the UPF over an N6 interface, and to a UL PDU Set sent by the UE. Further, a PDU Set Error Rate (PSER) defines an upper bound for the rate of PDU Sets (e.g., a set of IP packets constituting a PDU Set) that have been processed by a sender of a link layer protocol (e.g., RLC in RAN of a 3GPP access), where all of the PDUs in the PDU-Set are not successfully delivered by the corresponding receiver to the upper layer (e.g. PDCP in RAN of a 3GPP access). The PSER is used to determine an upper bound for a rate of non-congestion-related packet losses.

As described herein, XR devices (e.g., XR glasses, XR mobile UEs, and so on) may be supported by various client architectures, such as an architecture that includes an XR runtime, a Scene Manager, and a Media Access Function (MAF). The MAF may be part of a client device (e.g., the UE 104) that accesses and streams media. The client device may include codecs, content delivery protocols, 5G (or network) connectivity, a Media Session Handler (MSH), and other modules/services.

In some cases, an XR device may be tethered to a client device (e.g., the UE 104), such as a client device that runs or supports an XR application and/or other XR functions (e.g., the MAF, a lightweight scene manager, and so on). However, various issues can arise that relate to monitoring and reporting tethering link latencies (and data network link latencies), as well as the management of an end-to-end (E2E) QoS delay budget that meets latency requirements for XR applications.

In some cases, a tethering link may be a Wi-Fi tethering link, a 5G NR Sidelink/PC5 link (in either licensed or unlicensed spectrum), a 5G network, the Internet, and so on. In some cases, a Wi-Fi tethering segment (or any other unlicensed tethering access technology) and the Internet segment may not guarantee low latency. Thus, to achieve a low E2E latency, which facilitates the immersiveness and interactivity of XR applications, a device may adapt dynamically to a dynamic remaining delay budget in the 5G network, such as at the level of the 5G radio access network (RAN), in accordance with the total delay incurred elsewhere on an E2E path.

For example, a delay on a Wi-Fi link may change over time, depending on the interference generated by other nearby Wi-Fi networks operating within the same frequency band. Similar behavior can be expected of other unlicensed access technologies used for tethering, such as 5G Sidelink, or the PC5 interface, over unlicensed bands. In addition, the delay between the UPF and the application server (AS) depends on the location of the selected UPF, the selected edge/AS and on a network congestion level. Therefore, measurements may be used to estimate these time-varying delays on the non-5G segments (e.g., associated with the 5G core network and 5G RAN).

Thus, determining, with low overhead, the delays across non-5G network segments along the E2E path from an XR client to an XR server can assist in realizing the desired low latency for XR applications. For example, use of radio resource allocation and 5G RAN resource scheduling to expose the elapsed delays between a multimedia source and a 5GS transmitter of the multimedia traffic for XR applications may mitigate or solve the issues described herein.

User plane transport of XR applications may utilize content distribution protocols, such as those built on RTP/SRTP (secure RTP). RTP/SRTP enables header extensions, which allow for XR traffic awareness across a network from an application level to a radio level. For example, in addition to an RTP header extension for PDU Set marking, a pair of RTP header extensions, for timing and time marking, may provide in-band E2E delay measurements between an XR client and an XR server, or between other XR peers or nodes.

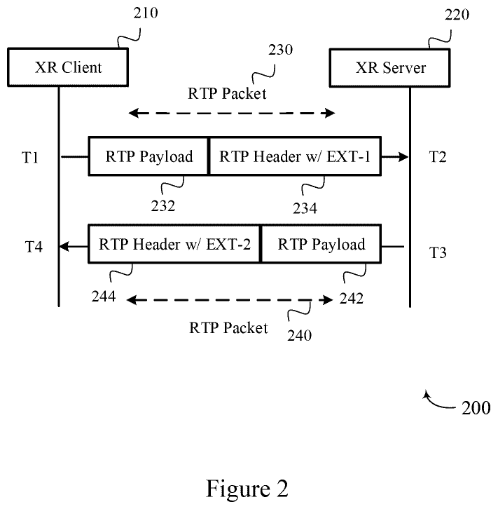

FIG. 2 illustrates an example measurement procedure 200 between an XR client 210 and an XR server 220 in accordance with aspects of the present disclosure. The procedure 200, which can be a request-response routine, enables RTP packets (e.g., PDU Sets) to carry timestamps that can assist in obtaining or determining measured delays representative of the E2E delays experienced by the media in the user plane. In some cases, the E2E connections may imply multi-hop links, including non-3GPP network paths, such as a DN link and a tethering link, as well as processing delays incurred within a mobile XR device from the XR application up to the 5GS modem L2 interfaces (e.g., SDAP/PDCP buffers).

The XR client 210 (e.g., a requestor, such as an XR application or XR device) transmits an RTP packet 230 to the XR Server 220 (e.g., a responder, such an AS or edge AS and/or an intermediate node, such as the ULE 104, the NE 102, and so on). The RTP packet 230 includes a payload 232 and a header 234, including an extension EXT-1. Similarly, the XR server 220 may transmit an RTP packet 240 back, which also includes a payload 242 and a header 244, including an extension EXT-2. The header extensions 234 and 244, as described herein, can be used to measure one or several delays, when node endpoints are synchronized.

For example, delays may be computed based on different timestamps associated with the RTP packet 230 transmission and a similar RTP packet 240 transmission between the XR client 210 and the XR server 220. For example, T1 may be an “originate” timestamp, T2 may be a “receive” timestamp, T3 may be a “transmit” timestamp, and T4 may be a “destination” timestamp, as depicted in FIG. 2.

Delays, then, may be determined on an E2E basis or hop-by-hop basis (e.g., when any hop endpoint is additionally time synchronized and aware of the RTP header extensions for in-band delay measurements). For example, the header extension EXT-1 of the RTP header 234 can include the T1 timestamp, and the EXT-2 of the RTP header 244 can include the T1, T2, and T3 timestamps.

Thus, a one-way delay from a requestor to a responder is determined by T2−T1, and a one-way delay in the opposite direction is determined by T4−T3. Further, a RTT (round-trip time) is determined by (T4−T1)−(T3−T2) and a processing delay at the responder is determined as T3−T2. In some cases, time synchronization may be enabled via a Precision Time Protocol (PTP)/generic PTP (gPTP) procedure or various clock synchronization mechanisms.

As described herein, the systems and methods leverage the user plane traffic (e.g., the RTP packets 230 and 240 of FIG. 2) to expose a scheduling function (e.g., at the NE 102, such as a gNB or other base station) to sender timing information, which determines scheduling and allocation of resources based on the timing information. The gNB may allocate radio resources for both UL and DL traffic, being delay-aware with respect to the traffic to be allocated.

For example, the traffic may include an XR service corresponding to a multimedia XR application and associated PDU Sets. The gNB receives an information element having information useful for determining a remaining delay budget of a PDU of a PDU Set and/or a logically linked (e.g., representing the same Application Data Unit, e.g., a video frame, video slice, an audio sequence, and so on) set of PDUs (e.g., a PDU Set).

In some cases, the useful timing information (e.g., at the UE/gNB) associated with a media PDU or alternatively a PDU Set may be an absolute timestamp (e.g., a full NTP timestamp) or a partition of an NTP timestamp that indicates the absolute send time of a PDU or a PDU Set. Based on an established time synchronization via NTP, PTP, or similar procedures with the multimedia application sender, an intermediate device (e.g., the UE 104, the NE 102, a mobile handset modem/UE, and so on) may determine the elapsed time and the remaining time associated with a PDU or a PDU Set, relative to QoS requirements of PSDB of a logical channel, a radio bearer, and respectively, a QoS flow used to serve the PDU or the PDU Set.

As described herein, an RTP header extension may include the information element, such as a timestamp, which represents an absolute RTP sender time of an RTP PDU or a set of RTP PDUs that includes the PDU Set. For example, as depicted in FIG. 2, the information element may have a one-byte or two-byte format within an RTP header extension. In some cases, other containers may include sender timing information, such as RTP header extensions providing absolute sender timing information (e.g., excluding a non-stochastic RTP header timestamp) and/or PDU header extensions (e.g., a GTP-U header extension including sender timing information of one or more GTP-U PDUs as derived by the UPF in DL).

Further, while the UE 104 may perform various aspects of the technology described herein during UL, such aspects may be implemented in DL. For example, a UPF may determine an absolute remaining delay budget or absolute sender time and indicate the timing information to a gNB (or other base station) within an information element (e.g., within a GTP-U header of a PDU or PDU Set).

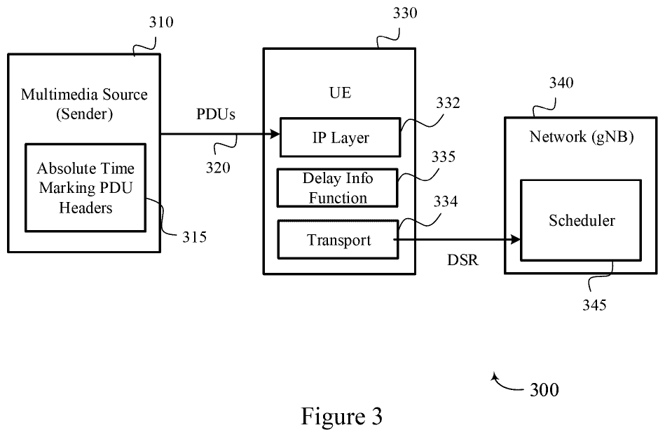

FIG. 3 illustrates an example block diagram 300 that depicts uplink delay-aware radio resource allocation in accordance with aspects of the present disclosure. A multimedia source 310 (or sender), in UL direction, buffers multimedia data captured or generated by one or more sources and peripherals (e.g., microphones, tactile/haptic inputs, camera, video recorders, pose recorders, and so on).

The multimedia source 310 determines PDU Set partitioning (e.g., packets corresponding to the same ADU), packetizes a PDU Set in PDUs (e.g., RTP PDUs), and timestamps one or more PDUs or a PDU Set (e.g., one PDU of a PDU Set, such as the first or the last PDU, or alternatively all PDUs of the PDU Set) with a sender timestamp. The multimedia source 310 releases the PDUs out of an associated transmit buffer. As described herein, the multimedia source 310 may apply PDU headers, such as absolute time marking PDU headers 315. The timestamps may be part of an RTP header extension and include the absolute sender time information.

The multimedia source 310 is connected to or coupled to a UE 330 or modem via a communication medium or interface 320. The interface 320 may be a wired or wireless link (e.g., a memory bus, a wired tethering link, a wireless tethering link, and so on). In some cases, a common UE or device may include both the multimedia sender 310 and the UE 330, such as a mobile device, an XR HMD, and so on. In other cases, the multimedia sender 310 and the UE 330 are different devices (e.g., different peripheral devices), such as headphones, XR UEs, XR glasses/H/IDs, joysticks, haptic gloves, haptic remote controllers, and so on, and communicate over a tethering wired or wireless connection.

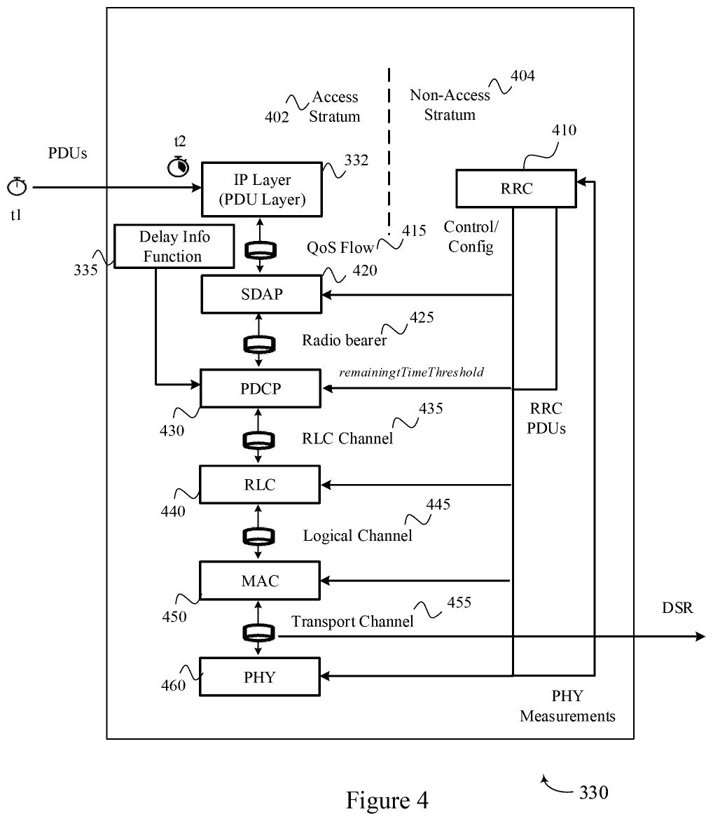

The UE 330, in all cases, may include rules that facilitate parsing PDU headers to extract timing information marked by the multimedia sender 310. For example, the UE 330 receives the PDUs at an IP layer 332 and utilize a delay information function 335 to determine delay timing information, such as a remaining delay budget. The UE 330, via a transport function 334, perform a Delay Status Reporting (DSR) procedure to report to a scheduler function 345 of a network entity 340 timing information that is based on the delay timing information. The scheduler 345, as described herein, may then perform delay-aware radio resource allocation, such as by prioritizing and/or allocating radio resources for the PDUs based on the received delay timing information. Further details regarding the delay information function 335 will now be described with respect to FIG. 4.

FIG. 4 illustrates an example block diagram depicting components of the UE 330 that determine a remaining delay budget for a delay-aware radio resource allocation in accordance with aspects of the present disclosure. Upon receipt of PDUs from the multimedia sender 310, the UE 330 applies a modem configuration at an access stratum 402 for a QoS flow 415 and a radio bearer 425 associated with the multimedia sender 310 to determine the timing information of a PDU or PDU Set, as marked by the multimedia sender 310. Further, a Service Data Adaptation Protocol (SDAP) 420 can receive control and/or configuration information from RRC 410 (within Non-Access Stratum 404).

In some cases, the UE 330 may determine, based on QoS flow parameters (e.g., PSDB, PDB) of the QoS flow 415, a remaining delay budget associated with a PDU or PDU Set. For example, the UE 330 may, upon time synchronization, determine an elapsed time from an absolute sender time (e.g., t1) until a time (e.g., t2) or moment when PDU or PDU Set is available in its access stratum buffers (e.g., at Layer 2 PDCP PDU buffers level).

When enabled by the modem configuration, the UE 330 may determine the absolute remaining delay budget of a PDU or PDU Set. The UE 330 may compute this quantity (e.g., by subtraction) from a QoS flow PDB/PSDB parameter associated with the radio bearer 425 of corresponding PDCP SDUs and the determined elapsed time of the PDCP SDUs (e.g., of a PDU Set). When enabled, the UE 330 may determine the absolute remaining delay budget for a PDU, or a PDU Set, whenever the multimedia source 310 marks the absolute sender time information.

In some cases, the UE 330 utilizes an absolute remaining delay budget to determine discardTimer entities associated with one or more PDCP SDUs. The one or more PDCP SDUs may correspond to a PDU Set. For example, for a DRB (data radio bearer) corresponding to a QoS flow with PSDB of 15 ms, the UE 330 may determine that a PDU Set arrives at the access stratum 402 with an absolute timestamp t₁. Given t₁, the UE 330 may determine, based on a UE registered arrival time t₂, that an elapsed time of Δt=t₂−t₁ is associated with the PDU Set. In addition, the UE 330 may determine that an absolute remaining delay budget of r_{Δt}=15−Δt is left to service the PDU Set in UL.

The UE 330 may set the discardTimer of associated PDCP SDUs, received from the RRC 410, corresponding to the PDU Set to the r_{Δt} value (e.g., of the absolute remaining delay budget). In some cases, when the UE 330 determines the absolute remaining delay budget and sets the discardTimer of PDCP SDUs based on the absolute remaining delay budget, the UE 330 triggers a DSR procedure for a LCG comprising a LCH associated with the PDCP SDUs for which the discardTimer value of the absolute remaining delay budget satisfies a condition of being lower than the RRC 410 configured remainingTimeThreshold (received at a PDCP 430). The UE 330 triggered DSR may include a lowest discardTimer associated with the PDCP SDUs (e.g., a PDU Set), where the discardTimer value represents the absolute remaining delay budget in UL of the SDUs.

In such cases, the UE 330 may account for or consider any potential delays in the UL path from the multimedia source 310 to the network entity 340. For example, the UE 330 may account for delays due to a tethering link (e.g., Wi-Fi tethering, wired/USB tethering, and so on) or intra-UE delays (e.g., buffering, I/O processing, memory transfer, and so on) when scheduling UL resources.

The UE 330 may set the PDCP SDUs of the PDU Set determined to have a r_{Δt} absolute remaining delay budget with a discardTimer value of r_{Δt}, which counts down and triggers a DSR procedure when it drops under the remainingTimeThreshold set by the RRC configuration for the corresponding DRB. In some cases, the discardTimer may instead implement the timer entity initialized at 0 and counting up to the trigger threshold max(0, r_{Δt}−remainingTimeThreshold) to achieve the same trigger condition.

The UE 330 includes a Radio Link Control (RLC) layer 440, which supports a RLC channel 435, a MAC layer 450, supporting a logical channel 435, a Physical layer 460, and a transport channel 455, via which a DSR and/or PDUs are transmitted to the network entity 340.

For example, the network entity 340 receives a DSR MAC CE indication, and determines additional radio resource allocation to meet delay budget requirements of buffered SDUs for the DRB. In some cases, at the UE 330, the additional radio resources may be used along with dynamically increased logical channel prioritization for the logical channel 445, which corresponds to the DSR and is associated with delayed PDCP SDUs, or an associated delayed PDU Set.

In some embodiments, upon ingest at the Access Stratum 402, the UE 330 determines that r_{Δt}<0 for a PDCP SDU (or alternatively more PDCP SDUs as a PDU Set). The UE 330 may immediately trigger a DSR procedure indicating the remaining time as “0.” For example, a DSR MAC CE with a remaining time of “0” indicates to the network entity 340 that it should dynamically allocate resources for all DSR remaining data (e.g., the one or more PDCP SDUs) within the next available scheduling slot, or the UE 330 will discard the corresponding data and PDCP SDUs/PDU Set. Thus, when the gNB fails to schedule the corresponding resources in the next scheduling occasion given the slot format configured by the up-to-date slot format indicator (SFI)/TDD configuration, then the UE 330 may discard the corresponding PDCP SDUs/PDU Set data.

In some cases, a DSR MAC CE with a remaining time of “0” indicates to the gNB that the UE discarded 330 the associated DSR data as the UE 330 detects it already exceeded the QoS flow requirements and hence serving the DSR data would lead to additional usage of system resources that can be reallocated to other UEs or other LCGs.

In some cases, the UE 330 may dynamically signal in the DSR MAC CE one bit that indicates the expected behavior of the UE 330 to the gNB. The bit may indicate the dynamic behavior of the UE 330 between requesting immediate scheduling on a next UL resource and directly discarding PDCP SDUs followed by reallocation of free resources. In one example, a UE DSR MAC CE with “0” remaining time and the dynamic bit determining the UE behavior set (e.g., “1”) indicates that the UE 330 will wait until the next immediate scheduling occasion for the gNB to dynamically schedule the necessary radio resource for transmission of the PDCP SDUs (e.g., PDU Set data) associated with the DSR MAC CE indication. If the gNB fails/cannot allocate the radio resources, the UE 330 will discard the PDCP SDUs (e.g., PDU Set data) after the next scheduling occasion.

As another example, a UE DSR MAC CE with “0” remaining time and the dynamic bit determining the UE behavior unset (e.g., “0”) indicates that the UE 330 discarded, or alternatively will discard, the PDCP SDUs (e.g., PDU Set data) associated with the DSR MAC CE indication and that any resources that may be associated with the transmission of the PDCP SDUs may be freed for reallocation to other UEs, or other LCGs.

In some embodiments, the UE 330 may detect, compute, and record for an UL QoS flow, or alternatively a DRB, of a PDU Session a set of absolute remaining delay budget measurements. The UE 330 may further statistically process, per DRB, the collected set of absolute remaining delay budget and/or corresponding timing information to determine jitter statistics of the UL traffic. For example, the UE 330 may collect the absolute sender time corresponding to multiple PDCP SDUs/PDU Set data and determine traffic jitter statistics based in part on these values and/or on the traffic periodicity associated with the traffic of the QoS flow/DRB. The jitter statistics may include information elements that include at least one of: the average periodicity, the minimum (e.g., lower bound), maximum (e.g., upper bound), average and variance of the jitter and the minimum (e.g., lower bound), maximum (e.g., upper bound), and/or average and variance of the absolute remaining delay budget of the UL traffic. In some cases, these information elements may be part of a UE assistance information message container indicated to the gNB by the UE over non-access stratum signaling over a signaling radio bearer (SRB). For example, with respect to Release 18 of 3GPP, an example UE assistance information message container may contain the following format and additional following fields.

′′′

UEAssistanceInformation-v18xy-IEs ::= SEQUENCE {

| | | |
|---|---|---|
| ul-TrafficInfo-r18 | UL-TrafficInfo-r18 | OPTIONAL, |
| nonCriticalExtension | SEQUENCE { } | OPTIONAL |

UL-TrafficInfo-r18 ::= SEQUENCE (SIZE (1. . maxNrofPDU-Sessions-r17) ) OF PDU-SessionUL-

TrafficInfo-r18

PDU-SessionUL-TrafficInfo-r18 ::= SEQUENCE {

| pdu-SessionID-r18 | PDU-SessionID, |
|---|---|
| qos-FlowUL-TrafficInfoList-r18 | SEQUENCE (SIZE (1..maxNrofQFIs) ) OF QOS-FlowUL- |
| TrafficInfo-r18 | |
| } | |
| QOS-FlowUL-TrafficInfo-r18 ::= | SEQUENCE { |
| qfi-r18 | INTEGER (0..maxQFI), |
| jitterRange-r18 | SEQUENCE { |
| lowerBound-r18 | JitterBound-r18, |
| upperBound-r18 | JitterBound-r18, |

-- Timing expressed in integer values with a clock tick of 1 microsecond

| | | |
|---|---|---|
| average-r18 | INTEGER (0..8192), | |
| standard-deviation-r18 | INTEGER (0..2048) | |
| } | | OPTIONAL, |
| burstArrivalTime-r18 | CHOICE { | |
| referenceTime | ReferenceTime-r16, | |
| referenceSFN-AndSlot | ReferenceSFN-AndSlot-r18 | |
| } | | OPTIONAL, |
| trafficPeriodicity-r18 | INTEGER (1..640000) | OPTIONAL, |
| pduSetIdentification-r18 | BOOLEAN | OPTIONAL, |
| tetheredApplicationLink-r18 | BOOLEAN | OPTIONAL, |
| absRemainingDelayBudgetIdentification-r18 | BOOLEAN | OPTIONAL, |
| absRemainingDelayBudgetInfo-r18 | SEQUENCE { | |

-- Timing expressed in integer values with a clock tick of 1 microsecond

| | | |
|---|---|---|
| lowerBound-r18 | INTEGER (0..32768) | OPTIONAL, |
| upperBound-r18 | INTEGER (0..65536) | OPTIONAL, |
| average-r18 | INTEGER (0..65536) | OPTIONAL, |
| standard-deviation-r18 | INTEGER (0..16834) | OPTIONAL |
| } | | OPTIONAL, |
| . . . | | |
| } | | |
| ′′′ | | |

In some embodiments, the UE 330 may report, together with the UE UL traffic assistance information for a QoS flow, the state of the absolute remaining delay budget identification capability as either ON/OFF or any alternative Boolean encoding. In some cases, if the UE 330 did not provide the absolute remaining delay budget identification capability (e.g., absRemainingDelayBudgetIdentification) since it was configured to provide UL traffic information, or if the information previously provided for the absolute remaining delay budget identification (e.g., absRemainingDelayBudgetIdentification) may have changed since the last UEAssistanceInformation message report containing this information element, then:

when the UE 330 can identify and determine the absolute remaining delay budget (e.g., based on the RTP header extensions containing RTP sender absolute timing information) for the QoS flow, then: the absolute remaining delay budget information element is set to TRUE, otherwise; the absolute remaining delay budget information element is set to FALSE.

In some embodiments, the UE 330 may report to the network (e.g., upon a new specific network request for the UE 330) the capability to identify and determine delay information in support of delay-aware scheduling. For example, the UE 330 may report the remaining delay budget based on protocol headers (e.g., RTP/SRTP, or generically PDU header at the access stratum 402) that include timing information. In some cases, the network request may be a new RRC enquiry of UE capabilities that includes the identification and determination of the absolute remaining delay budget information.

In some embodiments, the UE 330 may additionally report if a multimedia source application is tethered to the UE 330 over a wired, or alternatively wireless, tethering link. Such information may be within an information element (e.g., tetheredApplicationLink) that indicates TRUE if the multimedia source application communicates with the UE modem over a tethered link connection, or FALSE if the multimedia source application communicates directly (e.g., via a memory bus or via physical media communications with the UE 330 or UE modem).

In some embodiments, the UE 330 may be configured to identify upper layers timing information (e.g., RTP header extensions that include RTP sender absolute timing information) and determine the absolute remaining delay budget of one or more PDUs, or alternatively of a PDU Set. For example, the configuration information may contain information elements describing the protocol including the PDUs (e.g., RTP), as well as the header elements (e.g., header extensions) that include the timing information (e.g., the RTP header extensions for in-band delay measurements).

Furthermore, the configuration may map the protocol description to at least one of a PDU Session, a 5-tuple including source/destination IP addresses, source/destination ports and protocol identifier, a QoS flow, a DRB, or a combination thereof. The configuration may be set to the UE modem via modem specific APIs exposing configuration options to upper layers (e.g., application layer and OS application space), via 3GPP service-based APIs configuring the UE 330 through non-access stratum (NAS) configuration via NAS signaling from a core network to the UE 330, or a combination thereof.

In some cases, the UE 330 is configured by the multimedia source application via OS specific APIs abstracting UE modem configuration options for indicating a protocol description, or similar configuration, and tethered link condition (e.g., tetheredApplicationLink TRUE/FALSE) associated with an UL QoS flow of the multimedia application. In some cases, the multimedia source application may interact with the 3GPP Media Session Handler (MSH) interfaces and APIs to configure the UE modem using an Application Function (AF) and the core network NAS signaling.

In some embodiments, the multimedia source application configures the MSH to request absolute remaining delay budget identification support from the UE modem based on a protocol description associated with a QoS flow. The protocol description included in a dynamic policy request may contain at least information related to the protocol format (e.g., RTP), an extension used to transmit absolute sender timing information (e.g., RTP header extensions for in-band delay measurements), PDU Set information (e.g., enablement of PDU Set detection and/or information of RTP extensions used to mark PDU Sets), tethered link condition (e.g., tetheredApplicationLink TRUE/FALSE), service data flow information (e.g., 5-tuple, session/application ID) and QoS application requirements.

The MSH sends the dynamic policy request to the AF, which processes the request and requests the core network Policy Control Function (PCF)/Network Exposure Function (NEF) for a QoS flow with the set of desired QoS parameters and enabled identification of the absolute remaining delay budget by the UE 330. The PCF determines the PCC rules, considering potential Service Level Agreements in place between network operator and application service provider (ASP), and configures an SMF (Session Management Function), which determines the session rules and QoS profile signaled to an AMF (Access and Mobility Management Function). The AMF configures the UE modem using the SM container and N1 interface over NAS signaling.

In some embodiments, a UE configured to identify and determine the absolute remaining delay budget for one or more QoS flows may be configured by the network with a second configuration (e.g., via RRC configuration parameters) corresponding to a multi-modal service ID including a set of one or more QoS flows of a service data flow of a multimedia application. The set of one or more QoS flows may include a subset of the one or more QoS flows first configured with the identification and determination of the absolute remaining delay budget. AS second configuration may comprise grouping the LCHs corresponding to the set of multi-modal QoS flows, and a common dynamic LCP policy applicable to LCP procedure of the LCHs based on the detected absolute remaining delay budget. The common dynamic LCP may be applied to the LCG comprising all the LCHs associated with the multi-modal QoS flows of a multimedia service data flow.

In some embodiments, the common dynamic LCP policy may include a set of alternate priorities, Priority Bit Rate (PBR), Bucket Size Duration (BSD), used by the UE 330 to dynamically prioritize the LCHs of the multi-modal service to match synchronously the multi-modal service ID QoS flows requirements coherently and jointly. For example, a UE may be configured with a LCG comprising 3 LCHs associated with a video, audio, and haptic data flows, and respectively, a set of default and alternate priorities, PBRs and BSDs for each of the 3 LCHs. The UE may adaptively select the alternate LCHs priorities, PBRs and BSDs to determine a LCP prioritization capable to satisfy the QoS flows corresponding to the 3 LCHs, based on the detected absolute remaining delay budgets corresponding to each of all 3 LCHs among. The UE may temporarily modify the priority of LCH associated with the tactile data flow, or alternatively, modify its PBR to infinity to prioritize the multiplexing of the tactile LCH over the video and audio ones at the MAC PDU level over the next scheduled grant. This may be triggered based on the absolute remaining delay budgets associated with the tactile LCH reaching a triggering condition, such as: lowest absolute remaining delay budget dropping below a threshold, average absolute remaining delay budget dropping below a threshold, and so on. Further, after the transmission over the next scheduled grant, the priority/PBR of the LCH corresponding to the tactile data flow may be set back to the default values.

Thus, in some embodiments, the technology described herein may utilize L2 radio layer existing higher layers timing information to determine an accurate absolute remaining delay budget, apply the determined accurate absolute remaining delay budget for delay-aware radio resource allocation in UL and DL, and configure a UE modem to identify the existing higher layers timing information embedded by a sender to mark in-band absolute timestamps (e.g., within the RTP header extensions for in-band delay measurements) to determine the accurate absolute remaining delay budget.

In doing so, the technology may improve the accuracy of the delay timing information that can be determined (e.g., up to 3.8 microseconds resolution based on RTP header extensions that include NTP timing information of 24 bits as of 6.18 fixed point bitwise representation extracted from the NTP 64-bit timestamp standard format), without new layering at the radio level (instead reusing identified information from existing PDU headers), providing applicability across various tethering connections (reusing RTP/UDP/IP and IP transport layers), among other benefits.

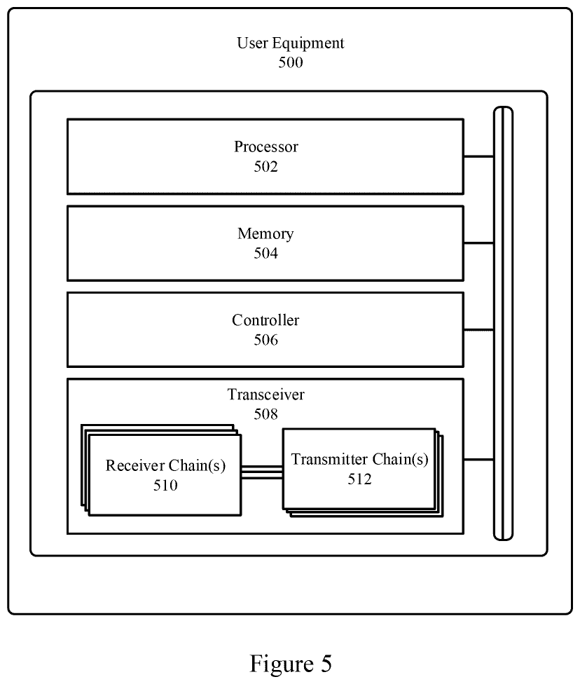

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to support a means for configuring the UE with a first configuration associated with timing information for multiple PDUs, receiving the multiple PDUs from a multimedia sender via a first protocol layer, determining delay timing information for the multiple PDUs based on the first configuration, wherein the determined delay timing information corresponds to multiple SDUs associated with the multiple PDUs at a second protocol layer, generating new PDUs at the second protocol layer that are based at least in part on the multiple SDUs, wherein each new PDU of the second protocol layer includes at least one SDU of the multiple SDUs and a corresponding header, and transmitting the new PDUs generated at the second protocol layer to a network entity.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

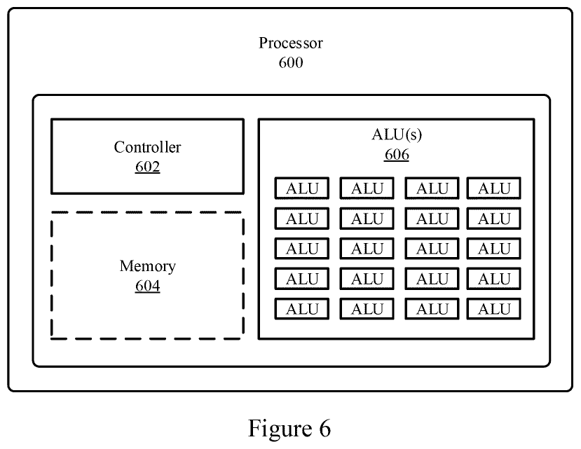

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. For example, the processor 600 may be configured to or operable to support a means for configuring the processor with a first configuration associated with timing information for multiple PDUs, receiving the multiple PDUs from a multimedia sender via a first protocol layer, determining delay timing information for the multiple PDUs based on the first configuration, wherein the determined delay timing information corresponds to multiple SDUs associated with the multiple PDUs at a second protocol layer, generating new PDUs at the second protocol layer that are based at least in part on the multiple SDUs, wherein each new PDU of the second protocol layer includes at least one SDU of the multiple SDUs and a corresponding header, and transmitting the new PDUs generated at the second protocol layer to a network entity.

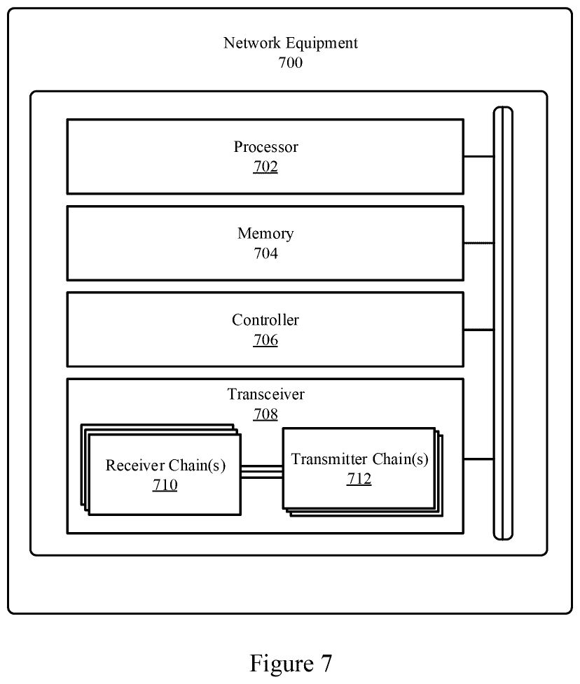

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to support a means for applying a permutation matrix to a parity-check matrix of a QC-LDCP code or to an information bits vector to which the parity-check matrix is applied, generating a codeword based on the application of the permutation matrix to the parity-check matrix of the QC-LDCP code, and transmitting the generated codeword to a receiver over a data channel.

As another example, the processor 702 may support wireless communication at the NE 700 in accordance with examples as disclosed herein. The NE 700 may be configured to support a means for receiving delay timing information for multiple PDUs that corresponds to multiple SDUs associated with the multiple PDUs and prioritizing and allocating radio resources for the multiple PDUs based on the received delay timing information.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

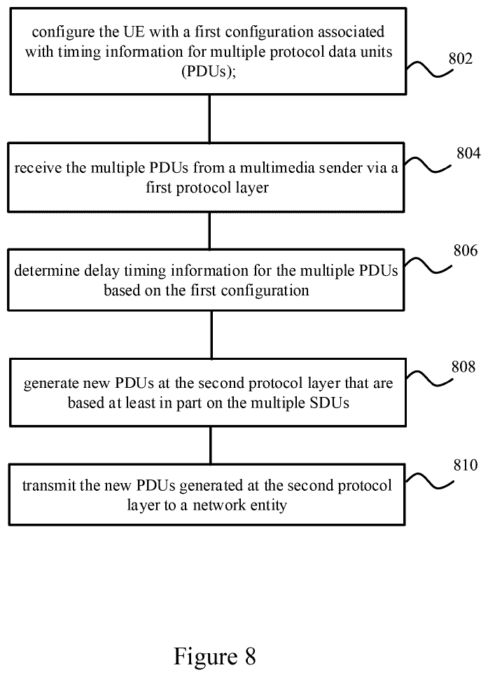

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions.

At 802, the method may include configuring the processor with a first configuration associated with timing information for multiple PDUs. The operations of 802 may be performed in accordance with examples as described herein. In some implementations, aspects of the operations of 802 may be performed by a UE as described with reference to FIG. 5.

At 804, the method may include receiving the multiple PDUs from a multimedia sender via a first protocol layer. The operations of 804 may be performed in accordance with examples as described herein. In some implementations, aspects of the operations of 804 may be performed by a UE as described with reference to FIG. 5.

At 806, the method may include determining delay timing information for the multiple PDUs based on the first configuration, wherein the determined delay timing information corresponds to multiple SDUs associated with the multiple PDUs at a second protocol layer. The operations of 806 may be performed in accordance with examples as described herein. In some implementations, aspects of the operations of 806 may be performed by a UE as described with reference to FIG. 5.

At 808, the method may include generating new PDUs at the second protocol layer that are based at least in part on the multiple SDUs, wherein each new PDU of the second protocol layer includes at least one SDU of the multiple SDUs and a corresponding header. The operations of 808 may be performed in accordance with examples as described herein. In some implementations, aspects of the operations of 808 may be performed by a UE as described with reference to FIG. 5.

At 810, the method may include transmitting the new PDUs generated at the second protocol layer to a network entity. The operations of 810 may be performed in accordance with examples as described herein. In some implementations, aspects of the operations of 810 may be performed by a UE as described with reference to FIG. 5.

It should be noted that the method described herein describes a possible implementation, and that the operations and the steps may be rearranged or otherwise modified and that other implementations are possible.

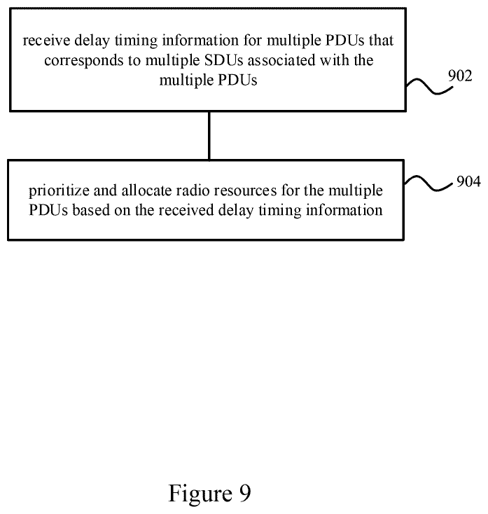

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions.

At 902, the method may include receiving delay timing information for multiple PDUs that corresponds to multiple SDUs associated with the multiple PDUs. The operations of 902 may be performed in accordance with examples as described herein. In some implementations, aspects of the operations of 902 may be an NE as described with reference to FIG. 7.

At 904, the method may include prioritizing and allocating radio resources for the multiple PDUs based on the received delay timing information. The operations of 904 may be performed in accordance with examples as described herein. In some implementations, aspects of the operations of 904 may be performed by an NE as described with reference to FIG. 7.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory;
at least one processor coupled with the at least one memory and configured to cause the UE to:
configure the UE with a first configuration associated with timing information for multiple protocol data units (PDUs);
receive the multiple PDUs from a multimedia sender via a first protocol layer;
determine delay timing information for the multiple PDUs based on the first configuration,
wherein the determined delay timing information corresponds to multiple service data units (SDUs) associated with the multiple PDUs at a second protocol layer;
generate new PDUs at the second protocol layer that are based at least in part on the multiple SDUs,
wherein each new PDU of the second protocol layer includes at least one SDU of the multiple SDUs and a corresponding header; and
transmit the new PDUs generated at the second protocol layer to a network entity.

2. The UE of claim 1, wherein the at least one processor is further configured to cause the UE to:
determine a transmission priority for each PDU of the new PDUs based on the determined delay timing information that corresponds to the multiple SDUs.

3. The UE of claim 2, wherein the at least one processor is further configured to cause the UE to:
transmit the new PDUs based on the determined transmission priority, by:
triggering a delay status reporting (DSR) procedure corresponding to the new PDUs,
wherein the DSR procedure includes reporting to the network entity timing information that is based on the delay timing information;
dynamically updating a logical channel prioritization (LCP) of a logical channel associated with the transmission of the new PDUs based on a second configuration for the UE,
wherein the second configuration includes a parameter set, including the following parameters:
alternate logical channel priorities;
alternate priority bit rates (PBRs); or
alternate bucket size durations (BSDs); and
grouping one or more logical channels to a Logical Channel Group (LCG),
wherein the LCG is mapped to a common multi-modal service ID associated with the new PDUs of the multimedia sender, and
wherein the multi-modal service ID enforces a common set of Quality of Service (QoS) and multi-modal synchronization parameters for the one or more logical channels of the LCG; or combinations thereof.

4. The UE of claim 1, wherein the first protocol layer is an Internet Protocol (IP) layer.

5. The UE of claim 1, wherein the second protocol layer is a Packet Data Convergence Protocol (PDCP) layer.

6. The UE of claim 5, wherein the at least one processor is further configured to cause the UE to:
determine multiple PDCP discard timers based on the delay timing information that corresponds to the multiple SDUs.

7. The UE of claim 1, wherein the at least one processor is further configured to cause the UE to:
receive an indication of the first configuration, by:
a UE programmatic interface exposed to the multimedia sender;
a dynamic policy request sent by a Media Session Handler (MSH) to a second network entity and determined based at least in part by the multimedia sender;
a UE programmatic interface exposed to the MSH; or
combinations thereof.

8. The UE of claim 1, wherein the at least one processor is further configured to cause the UE to receive the multiple PDUs from the multimedia sender via a communication medium, including:
a shared memory interface;
a tethered wireless communications interface; or
a tethered wired communications interface.

9. The UE of claim 1, wherein the multiple PDUs received from the multimedia sender are part of a PDU Set that includes a PDU Set information header.

10. The UE of claim 9, wherein the at least one processor is configured to determine the delay timing information for the multiple PDUs received from the multimedia sender based on identifying sender timing information within encapsulated protocol headers of the PDU Set.

11. The UE of claim 10, wherein the encapsulated protocol headers include real-time protocol (RTP) header extension elements containing timing information.

12. The UE of claim 10, wherein the delay timing information includes at least one of the following information elements:
a multimedia sender absolute timestamp that is mapped to an absolute time instance at which the multimedia sender released the multiple PDUs to the UE;
a multimedia sender absolute timestamp that is mapped to an absolute time instance at which the multimedia sender released the PDU Set to the UE;
an elapsed timestamp that corresponds to a timing interval that elapsed between the multimedia sender releasing the multiple PDUs to the UE and the UE receiving the multiple PDUs at the first protocol layer;
an elapsed timestamp that corresponds to a timing interval that elapsed between the multimedia sender releasing the PDU Set to the UE and the UE receiving at least one PDU of the PDU Set at the first protocol layer;
a remaining delay budget that determines a difference between a transmission delay budget of the multiple PDUs and the elapsed timestamp of the PDU; or
a remaining delay budget that determines a difference between a transmission delay budget of the PDU Set and the elapsed timestamp of the PDU Set.

13. The UE of claim 1, wherein the at least one processor is further configured to cause the UE to:
report a capability to determine the delay timing information to the network entity via:
an information element that is part of a UE traffic assistance information for uplink (UL); or
a UE capability radio resource control (RRC) message.

14. A processor for wireless communication, comprising:
at least one controller coupled with at least one memory and configured to cause the processor to:
configure the processor with a first configuration associated with timing information for multiple protocol data units (PDUs);
receive the multiple PDUs from a multimedia sender via a first protocol layer;
determine delay timing information for the multiple PDUs based on the first configuration,
wherein the determined delay timing information corresponds to multiple service data units (SDUs) associated with the multiple PDUs via a second protocol layer;
generate new PDUs at the second protocol layer that are based at least in part on the multiple SDUs,
wherein each new PDU of the second protocol layer includes at least one SDU of the multiple SDUs and a corresponding header; and
transmit the new PDUs generated at the second protocol layer to a network entity.

15. The processor of claim 14, wherein the at least one controller is further configured to cause the processor to:
determine a transmission priority for each PDU of the new PDUs based on the determined delay timing information that corresponds to the multiple SDUs.

16. A method performed by a user equipment (UE), the method comprising:
configuring the UE with a first configuration associated with timing information for multiple protocol data units (PDUs);
receiving the multiple PDUs from a multimedia sender via a first protocol layer;
determining delay timing information for the multiple PDUs based on the first configuration,
wherein the determined delay timing information corresponds to multiple service data units (SDUs) associated with the multiple PDUs via a second protocol layer;
generating new PDUs at the second protocol layer that are based at least in part on the multiple SDUs,
wherein each new PDU of the second protocol layer includes at least one SDU of the multiple SDUs and a corresponding header; and
transmitting the new PDUs generated at the second protocol layer to a network entity.

17. The method of claim 16, further comprising:
determining a transmission priority for each PDU of the new PDUs based on the determined delay timing information that corresponds to the multiple SDUs.

18. A network entity for wireless communication, comprising:
at least one memory;
at least one processor coupled with the at least one memory and configured to cause the network entity to:
receive delay timing information for multiple Protocol Data Units (PDUs) that corresponds to multiple service data units (SDUs) associated with the multiple PDUs; and
prioritize and allocate radio resources for the multiple PDUs based on the received delay timing information.

19. The network entity of claim 18, wherein the at least one processor is configured to cause the network entity to receive the delay timing information via an information element (IE) that indicates a remaining delay budget for the multiple PDUs.

20. The network entity of claim 18, wherein the at least one processor is configured to cause the network entity to receive the delay timing information via an information element (IE) that indicates a remaining delay budget for a PDU Set that includes the multiple PDUs.
